(19) United States
(12) Patent Application Publication
(10) Pub. No.: US 2005/0108131 A1
(43) Pub. Date: May 19, 2005

(54) Box office participating securities (BOPS)

(76) Inventor: Thomas T. Halikias, New York, NY (US)

Correspondence Address: McCARTER & English, LLP;Four Stamford Plaza, 107 Elm Street, Stamford, CT, 06902, US

(21) Appl. No.: 10/987,969

(22) Filed: Nov. 12, 2004

Related U.S. Application Data
(60) Provisional application No. 60/523,500, filed on Nov. 17, 2003.

(51) Int. Cl. G06F 17/60

(52) U.S. Cl. 705/35

(57) ABSTRACT

A system and method are provided for use as a valuation model for film(s) and/or the creation of investment instrument(s) for securitizing film financing. The system and method may be used to create and/or establish a special purpose vehicle (SPV) valued, at least in part, on the potential box office revenues associated with a film. The system and method also extends to potentially issuing SPV units/shares to investor(s). A studio that takes advantage of the system/method beneficially receives a number of advantages, including: (i) funds for use in connection with the film, (ii) market intelligence with regard to film-related expectations, and (iii) a hedging mechanism with respect to the film.

### CROSS-REFERENCE TO RELATED APPLICATION

The present application claims the benefit of a co-pending provisional application entitled “Box Office Participating Securities (BOPS)” which was filed with the U.S. Patent Office on Nov. 17, 2003 and assigned Ser. No. 60/523,500. The entire contents of the foregoing provisional patent application are hereby incorporated by reference.

### TECHNICAL FIELD

The present disclosure relates to a valuation model and related investment instruments for secuiritizing film financing. More particularly, the present disclosure relates to a system and method for creating/establishing a special purpose vehicle (SPV) based, at least in part, on the potential box office revenues associated with film(s), and valuing and issuing units (i.e. shares) to investor(s) based on the SPV.

### BACKGROUND OF THE INVENTION

Historically, film financing has been relegated to a limited number of corporate investors and to the private sector. The extreme and uncertain risks of film production include: production delays, cost overruns, questionable accounting standards, unsatisfactory production value, and box office failure. In today's market, investors are not only called upon to provide financing for entire projects, but they also provide funding for each stage of production separately. This financing separation allows investors to concentrate on specific risks and to be compensated accordingly.

Despite the recent segmentation of financing, film funding remains shielded from the public at large, and is maintained within the corporate or private ranks. Long production cycles and vilified accounting practices have limited the public investors' appetite for any type of production related investment vehicles. However, the ability to circumvent the industry's internal accounting methods may be the first step towards securitizing film financing.

Print and advertising (P&A) funding encompasses most post-production needs, including: producing multiple film prints, advertising, publicity, promotion, etc. As the world goes digital, the expense of multiple prints will be replaced by the cost of digital delivery and projection. As a result, the term P&A funding may be replaced by “distribution” funding. A financing mechanism for P&A costs is generally required in the film industry.

Despite efforts to date, a need remains for improving the funding options available to the film industry. A further need exists to expand the universe of individuals/entities that have an opportunity to participate in the funding of film-related enterprises. Still further, a need exists for the film industry to be provided with enhanced mechanism(s) for hedging (in whole or in part) their substantial investment in the production, promotion and/or distribution of film products.

### SUMMARY OF THE INVENTION

The present disclosure provides a system and method that may be used as a valuation model for film(s) and/or the creation of investment instrument(s) for securitizing film financing. More particularly, the present disclosure relates to a system and method for creating/establishing a special purpose vehicle (SPV) valued, at least in part, on the potential box office revenues associated with a film, and issuing SPV units/shares to investor(s).

The funds raised according to the present disclosure may be advantageously derived from the anticipated box office receipts of a particular film or group of films. In an exemplary embodiment of the present disclosure, holders of the SPV shares/security will receive a payout based on an encompassing regression valuation model applied to the film's, or group of films', final U.S. box office receipts.

The investment instruments created or developed through application of the disclosed system/method allow investors to participate in the success of theatrically distributed films, while providing film “studios” and/or their affiliates needed funding, a barometer of a project's expectations, and a hedge against the film's (or films') performance. As used herein, the term “studios” is a broad term, including all aspects of the film industry. In typical applications of the present disclosure, the issuer of the investment instruments will have the ability to determine the degree to which the film's (or films') performance is hedged based on the level of funding sought, the market's expectations, and the payout parameters associated with the investment instruments.

In an exemplary embodiment of the present disclosure, the disclosed system involves the application of an encompassing regression valuation model in determining the payout of an investment instrument based on the final U.S. box office receipts of a film or group of films. One direct result of this exemplary embodiment of the invention will be a tradable/marketable security, e.g., a security that is traded on a public exchange, that allows investors to partake in the success of specific films, while providing studios, or their affiliates, the financing needed for these films.

A film's success is generally tied to a number of tangible and intangible ingredients. Unlike most traditional businesses, each film is uniquely independent and its expected success cannot be easily extrapolated from previous films. While a broad industry analysis may link particular attributes to a film's box office success, the combination of such attributes is extremely volatile and remarkably unreliable as a predictive measure. Quantifying the contribution of particular attributes, e.g., a star's drawing power or that of a particular director, is generally, at best, a relative measure of the potential box office success of a project and any group of potential attributes is generally subject to other limiting constraints in terms of their predictive accuracy. Combinations that may have worked previously may fail in future applications due to changes in the underlying film industry environment (or other external factors).

In addition to serving a unique industry, the investment instruments' determinate, i.e., a film's box office receipts, is also unprecedented. While widely publicized, the financial ramifications of a film's box office success impacts upon numerous participants in a variety of ways. Theaters, distributors, producers and talent all lay claim to differing components of the box office success. Additionally, each player's specific “take” varies from film to film. In no other industry is such a top line number quoted and utilized without regard for intermediary figures (as an example, figures for Coke® sales represent its wholesale activity, not retail activity by chain supermarkets, etc).

One particular advantage of the system/method of the present disclosure is that it allows studios to raise funds based on the anticipated box office receipts of a given film or group of films. In its simplest form, a distributor determines a percentage of the expected gross box office receipts it needs for financing and then issues the appropriate investment instrument to raise the needed funds. The funds raised through implementation of the investment instruments of the present disclosure could represent anywhere from 1% (or less) to 100% of a film's expected/projected box office receipts.

These and other features and benefits of the disclosed system and method will be apparent from the detailed description which follows, particularly when reviewed in conjunction with the figures appended hereto.

### BRIEF DESCRIPTION OF THE FIGURE

To assist those of skill in the art to which the subject matter of the present disclosure appertains to make and use the disclosed system and method, reference is made to the accompanying figures, wherein:

FIG. 1 is a flow chart for an exemplary implementation of the disclosed system and method; and

FIG. 2 is an exemplary Offering Memorandum for use in illustrative implementations of the present disclosure.

### DETAILED DESCRIPTION OF EXEMPLARY EMBODIMENT

As noted above, the present disclosure provides a system and method that may be used as a valuation model for film(s) and/or the creation of investment instrument(s) for securitizing film financing. The disclosed system and method may be used to create and/or establish a special purpose vehicle (SPV) valued, at least in part, on the potential box office revenues associated with a film. The disclosed system and method also extends to potentially issuing SPV units/shares to investor(s).

As an example, Studio X has just finished production on its latest blockbuster “Terminal”. The film stars Tom Cruise and is directed by Steven Spielberg. While the cost of the film was only $60 million dollars, Studio X expects box office receipts to be closer to $80 million. After consulting their investment bank, Studio X decides to raise 25% of the expected box office gross, i.e., $20 million, for advertising. The investment bank rounds up investors and then informs Studio X that the “market” is estimating the film will clear more than $100 million. Desiring to “lock-in” the market's perception, Studio X maintains their 25% target and thus raises $25 million. The Studio decides to allocate the extra $5 million raised to further advertising. The advertising blitz result is an extraordinary first weekend and the film goes on to gross $120 million. Although Studio X's obligation to its investors is now $30 million (i.e., 25% of the gross box office revenues for the film), the windfall from the additional box office receipts and improved ancillary sales easily covers that obligation.

As for the public investor, he/she purchased shares in a special purpose vehicle (SPV) that holds the distributor's final payout obligation. In this exemplary embodiment, the SPV was divided into a million shares, each priced at $25. The investor initially paid $2,500 for 100 shares, but the film's great success has increased the value of his/her holdings to $3,000, or $30 per share.

From the investment bank's perspective, Studio X needed to raise funds for “Terminal”. Production had been complete and the studio was looking to raise advertising dollars. The bank explained the added benefits of issuing the box office-related investment instrument to those responsible for production/distribution of the film according to the advantageous system/method of the present disclosure. Issuance of the investment instrument will signal the market's perception of the film, hedge the exposure of the film producer/distributor, and increase public awareness of the film. Liking these beneficial attributes, Studio X decides to issue a 25% instrument. The investment bank confers with industry-knowledgeable investors and discovers that there is great buzz around the film and that investors are willing to bid up the “expected box office returns” in order to assure themselves an allocation. It appears that the current 25% instrument will clear at $100 million. The bank relays this information to Studio X, which decides to take in the additional dollars to further promote the film.

Having finalized the studio's intent, the investment bank proceeds to create a SPV with one million shares outstanding. The only asset that backs the SPV is Studio X's, or its representative's, obligation to pay 25% of the final box office receipts for “Terminal” to holders of the SPV shares. The payment will be made at a predetermined time (or based on a predetermined event), e.g., one year from the issuance of the instrument, with a possible six-month extension. Prior to and through the film's release, the instrument trades actively on an exchange (or through other means) and settles at the price of $30. At the maturity, Studio X pays the SPV its obligation and the securities are redeemed for cash or a possible equivalent, e.g. share's of the issuing studio.

As stated, the above exemplary implementation is a simple example according to the system/method of the present disclosure. Iterations include raising a single sum, plus a percentage of gross receipts (e.g., $10 million plus 15% of box office receipts) or having a more sophisticated payout structure (e.g., 25% up to $100 million and then 20% above $100 million).

Thus, this application relates, in one exemplary embodiment, to the application of an encompassing regression valuation model in determining the payout of an investment instrument based on the final U.S. box office receipts of a film or group of films. The simplest regression formula according to this exemplary embodiment is:
Y=A+B*X (1)
Where:
Y is the payout figure
A is cash raised, and thus owed, that is not related to the box office figures;
B is the percentage payout of the final box office figures (i.e., 25% in the above-referenced example), and finally;
X being the final US box office receipts of a film(s).

Alternative, i.e. more complex, regression valuation models are contemplated for use according to the present disclosure. Thus, for example, the following regression models (2) and (3) may be employed as an elaboration of regression model (1) discussed above:

$$\begin{matrix}Y = {\sum }_{i = 1}^{∞} {\sum }_{j = 1}^{∞} {A}_{i} + {B}_{j} * X & ( 2 ) \\ Y = {\sum }_{i = 1}^{∞} {\sum }_{j = 1}^{∞} {A}_{i} + {B}_{j} X + {\sum }_{k = 1}^{∞} {\sum }_{m = 2}^{∞} {N}_{k} {X}^{n} & ( 3 )\end{matrix}$$

Where:

$${\sum }_{k = 1}^{∞} {\sum }_{m = 2}^{∞} {N}_{k} {X}^{n}$$

is the sum of possible derivative payout functions (i.e., adds curvature to the payout relationship)

Each of the foregoing regression models will yield a payout figure (Y) based on the payout figure (X). Selection from among the exemplary regression models (1)-(3) or alternative regression model(s) known to persons skilled in the art may be based on a variety of factors, including, for example, the desired level of precision in calculating the payout figure (Y) and the availability of data required to utilize respective regression models.

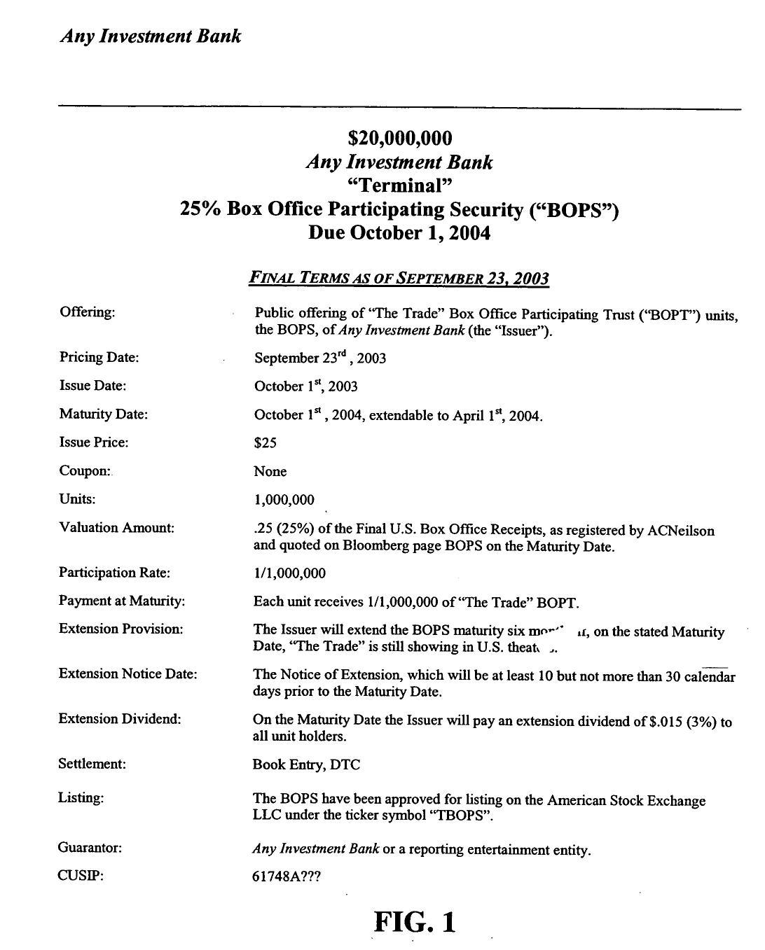

With reference to FIG. 1 which sets forth an exemplary flow chart related to implementation of the disclosed system and method, it is noted that initially an Investment Bank derives relevant information concerning the revenue prospects and financial needs associated with a film (or group of films). Syndication of a film property (or film properties) is expressly contemplated according to the present disclosure. The Investment Bank collects relevant information from all appropriate resources/information sources. Thus, as shown in the flow chart of FIG. 1, the Investment Bank derives information from an Investor Base (as to “market expectations and appetite”) and the Studio (as to “studio expectation and appetite). Based on such information, the Investment Bank calculates an estimated/projected box office revenue figure (e.g., based on U.S. box offices). In the exemplary flow chart set forth in FIG. 1, the initial security value is calculated as “Y” based on the valuation regression model set forth therein applied to a film(s) projected box office revenues.

Once the “Y” value is projected, the Investment Bank proceeds to create an SPV for purposes of financing the film(s). The SPV is fully documented by or on behalf of the Investment Bank, e.g., by lawyer(s) familiar with applicable regulatory requirements. Appropriate steps are taken to “secure the SPV obligation from the Studio,” i.e., ensure that the Studio, or its representative, is contractually obligated to fulfill its payment obligations (and any other obligations, e.g., audit requirements, marketing and promotion obligations, etc.) in support of or in connection with the SPV. Again, lawyer(s) familiar with applicable contractual parameters may be involved in undertaking to secure the studio's obligations pursuant to the SPV.

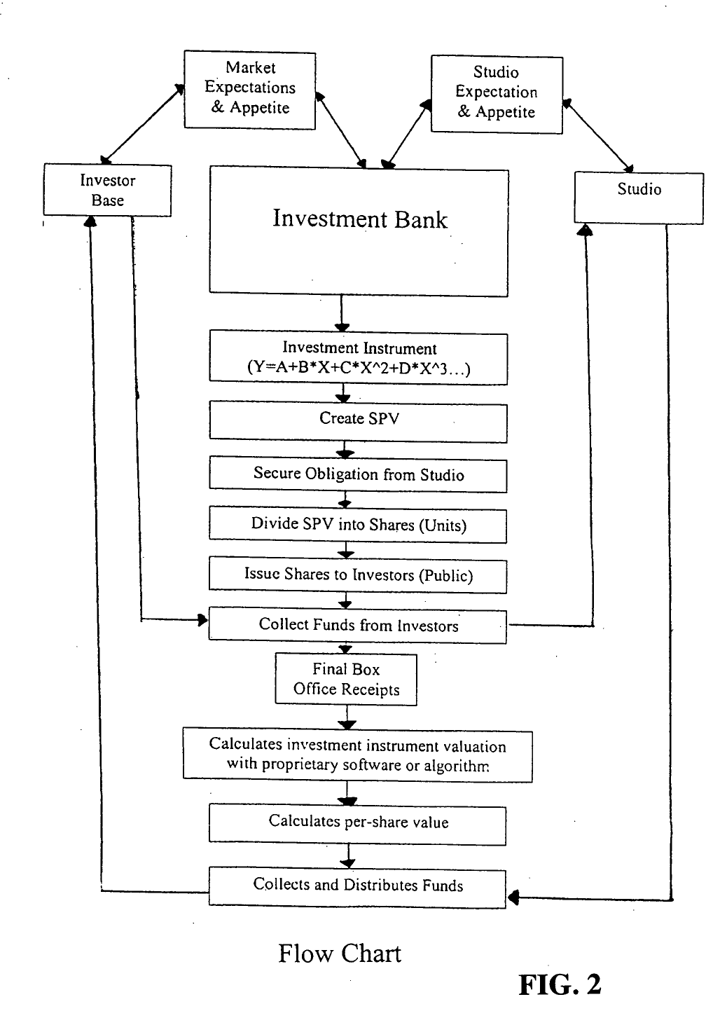

The SPV is divided into units (i.e., shares) by the Investment Bank. The number of units/shares and initial valuation of each such units/shares is well within the expertise of investment banking personnel, based on experiences in establishing tradable securities in other commercial contexts. The units/shares are then offered to investors, i.e., the public, for purchase. In offering such units/shares to the investment community, the Investment Bank complies with applicable regulatory obligations. An exemplary Offering Memorandum for the $20 million SPV associated with “Terminal” is set forth in FIG. 2. As set forth thereon, material terms associated with an SPV according to the present disclosure may include relevant dates, valuation parameters, size of offering and the like.

The Investment Bank then proceeds to collect funds from the investors, making appropriate book entries and complying with all applicable regulatory requirements. The funds are remitted to the Studio (less the Investment Bank's fee and any other applicable fees/disbursements) and such funds are used by the Studio in the manner provided in the SPV, e.g., to produce/distribute the film. Trading of the units/shares may occur post-issuance, and the value of the units/shares may vary based on the market's real time perception of the likely pay-out pursuant to the terms of the SPV. Thus, a measure of liquidity is generally established for investors in the units/shares.

Once the final box office receipts are tabulated by an independent agent (as defined in the SPV), the relevant information will be relayed to the Investment Bank and the Investment Bank calculates the investment instrument's valuation. An appropriate software application and/or algorithm may be employed to make such calculation(s), consistent with the terms of the SPV. The software application is generally run on an appropriate processor, with the results displayed or otherwise reduced to tangible form. Information relevant to the software application and the results generated thereby are typically stored in computer memory associated with the processor, as will be apparent to persons skilled in the art. Thereafter, the per-share pay-out value for individual units/shares is calculated by the Investment Bank. The Investment Bank then collects the pay-out funds from the Studio, or its representative, and makes the applicable distributions to the holders of the units/shares.

Of note, once the units/shares are issued to the public, the Studio bears no risk with respect to the performance of the film(s) for purposes of the SPV. Thus, the SPV of the present disclosure provides an advantageous hedging mechanism and an invaluable source of market insight for Studios and others involved in producing/distributing film properties. Other advantageous features and functionalities associated with the system/method of the present disclosure will be readily apparent to persons skilled in the art from the detailed description and appended materials associated herewith.

In an exemplary embodiment of the present disclosure, the disclosed system/method thus includes or entails (i) developing an estimate of potential box office revenues associated with a film (or group of films), e.g., based on relevant criteria such as actors/actresses, director, production cost, prior productions in the genre, etc., (ii) determination of an amount to be raised through the creation and issuance of an instrument that is secured (at least in part) based on the box office revenues of the film, for use in funding production/distribution costs associated with the film , and (iii) creating a security (e.g., SPV) to be offered to investor(s) that will pay out to the security holder based on the ultimate box office revenues of the film. In an exemplary embodiment of the disclosed system/method, the amount to be raised may be determined based on a percentage of the estimated box office revenues, e.g., 25% thereof. The funds (net of issuance-related costs and expenses) generated through issuance of the security may be used to fund P&A (distribution) expenses associated with the film(s) or other studio-related costs/expenses.

Although the present system/method has been described with reference to exemplary embodiments and implementations thereof, it is to be understood that the present disclosure is not limited to such exemplary embodiments and/or implementations. Rather, the present disclosure encompasses embodiments and implementations that fall within the spirit and scope of the present disclosure, including modifications, changes and/or enhancements that will be apparent to persons skilled in the art based on the foregoing disclosure.

1. A method for creating a special purpose vehicle (SPV), comprising:
(i) aggregating an estimate of potential box office revenues associated with at least one film based on market information;
(ii) determining an amount to be raised through creation and issuance of an instrument, such instrument to be secured at least in part based on box office revenues of said at least one film, wherein said amount to be raised is for use in funding at least one of production costs and distribution costs associated with the film, and
(iii) creating an SPV to be offered to one or more investors that will pay out to the one or more investors based at least in part on ultimate box office revenues of the film.

2. An SPV created according to the method of claim 1.

3. The method of claim 1, wherein SPV units/shares are offered to one or more investors.

4. The method of claim 1, wherein a regression valuation model is used in determining the payout based on the SPV.

5. The method of claim 1, wherein a studio retains an investment bank to perform the recited steps.

6. The method of claim 5, wherein the studio receives at least one of the following through retention of said investment bank: (i) funds for use in connection with the at least one film, (ii) market intelligence with regard to film-related expectations, and (iii) a hedging mechanism with respect to the at least one film.
